(19) United States
(12) Patent Application Publication
(10) Pub. No.: US 2020/0037823 A1
(43) Pub. Date: Feb. 6, 2020

(54) DEVICE AND METHOD FOR PRECISE TEMPERATURE CONTROL OF BEVERAGES

(71) Applicant: David PENSAK, Wilmington, DE (US)

(72) Inventor: David PENSAK, Wilmington, DE (US)

(21) Appl. No.: 16/525,196

(22) Filed: Jul. 29, 2019

Related U.S. Application Data
(60) Provisional application No. 62/712,533, filed on Jul. 31, 2018.

(51) Int. Cl. A47J 41/00; C09K 5/06

(52) U.S. Cl. CPC A47J 41/0044; C09K 5/066

(57) ABSTRACT

Devices that utilize phase change materials to maintain objects, such as beverage containers, within a precise temperature range for extended periods, without the need for ice, open flames, or mechanical heating or refrigeration, are disclosed. Methods of maintaining such objects within a precise temperature range for extended periods, without the need for ice, open flames, or mechanical heating or refrigeration, are also disclosed.

### CROSS-REFERENCE TO RELATED APPLICATIONS

This claims benefit of U.S. Provisional Application No. 62/712,533, filed Jul. 31, 2018, the entire contents of which are incorporated by reference herein.

### FIELD OF THE INVENTION

This invention relates to the thermal maintenance of a beverage. In particular, the invention provides a precise temperature control device and method utilizing phase change materials to maintain a beverage, such as wine or beer, at a relatively constant temperature for an extended period of time.

### BACKGROUND

It is generally accepted among wine connoisseurs and enthusiasts that selecting the optimal serving temperature for any particular wine is important to bring out the complex and sophisticated flavors and aroma of the wine. In fact, there are many published lists of serving temperatures optimized for particular wines. However, despite the fact that any given vintage of wine may have an optimal serving temperature that differs from another, red wines are generally served at room temperature, whereas white wines are served on ice. For the latter, most restaurants will bring the white wine to the table in an ice bucket. In addition to wine, different styles of beer may also have an optimal temperature. What is more, people may vary on their favorite temperature for drinking certain types of beer. In general, mass market pilsners and light lagers typically have an optimal temperature that is colder compared to Belgian and Scottish ales or stouts. For the most part however, beer is stored in the refrigerator or on ice in a cooler and served cold. These typical storage and serving practices, however, are not typically optimized for any particular variety of wine or beer and, therefore, many of the complex flavors and aromas are left unrealized by the consumer.

Thus, there is a need for precise temperature control to maintain beverages at their optimal storage and serving temperatures to prolong shelf-life and to maximize their flavors and aroma. To date, however, precisely controlling the temperature for each variety of beer and/or wine offered at any particular restaurant or kept at one's home is not always a practical endeavor. The most obvious reason for this is that the cost of maintaining a large number of wine and beer coolers, each set at a different temperature, is very expensive and takes up considerable space and resources. Moreover, there are limited, effective ways to maintain precise temperature control of the wine bottle once it is served.

Therefore, a need exists for a portable thermal maintenance/control device that can be used in the food and beverage service industry for consistent and precise temperature control of beverages for extended periods of time—in some cases up to 2 to 6 hours or more. The present invention satisfies this need and provides a low-cost and safe option for the food and beverage industry.

### SUMMARY

Described herein are devices and methods for precisely controlling the temperature of an object for a predetermined period of time. In particular aspects, the object is a beverage container. In one aspect, a temperature control device is provided herein that includes one or more enclosures in which is disposed a phase change material, wherein each enclosure comprises at least one conformable layer, wherein the phase change material has a melting temperature within about 5° C. of a predetermined temperature, and wherein the temperature control device is enabled to maintain at least the surface of an object within about 5° C. of the predetermined temperature for at least about 10 minutes when the object is placed in substantially direct contact with one or more of the enclosures. In some embodiments, the device comprises a plurality of enclosures in which is disposed a phase change material.

In an embodiment, the predetermined temperature is in a temperature range selected from the group consisting of: (i) about 5° C. to about 10° C.; (ii) about 10° C. to about 15° C.; (iii) about 15° C. to about 20° C.; and (iv) about 70° C. to about 85° C. In another embodiment, the phase change material comprises one or more organic molecules. For instance, the organic molecule may be selected from the group consisting of an esterified vegetable oil, a long chain fatty acid, a polyol, a paraffin, a polyacrylamide, and a combination thereof. In particular embodiments, the organic molecule is an esterified vegetable oil.

In some embodiments, the conformable layer of each enclosure comprises a flexible polymer. For instance, the flexible polymer may be selected from the group consisting of polyamide, polyethylene, polychlorotrifluoroethene, polystyrene, polyethylene terephthalate, polypropylene, and any combination thereof.

In one embodiment, each of the enclosures is connected to at least one other enclosure and wherein the temperature control device is enabled to be disposed at least partially around the circumference of a beverage container. In another embodiment, the beverage container is selected from the group consisting of a bottle, can, box, and pouch.

In another embodiment, the phase change material has a melting temperature within about 2° C. of a predetermined temperature, and wherein the temperature control device is enabled to maintain at least the surface of an object within about 2° C. of the predetermined temperature. In still other embodiments, the temperature control device maintains the surface of the object within about 2° C. of the predetermined temperature for at least about 1 hour when the object is placed in substantially direct contact with one or more of the enclosures. In yet others, the temperature control device maintains the surface of the object within about 2° C. of the predetermined temperature for at least about 1.5 hours when the object is placed in substantially direct contact with one or more of the enclosures. In some embodiments, the temperature control device maintains the surface of the object within about 2° C. of the predetermined temperature for at least about 2 hours when the object is placed in substantially direct contact with one or more of the enclosures.

Another aspect of the present invention features a method for controlling temperature of an object within a predetermined temperature range for a predetermined time period, which includes the steps of (a) providing a temperature control device comprising one or more enclosures in which is disposed a phase change material, wherein each enclosure comprises at least one conformable layer, and wherein the phase change material has a melting temperature within about 5° C. of a predetermined temperature; (b) placing the temperature control device in substantially direct contact with at least a portion of a surface of an object, wherein the object comprises contents; and (c) maintaining the temperature control device in substantially direct contact with the object for a predetermined period of time. In this method, the temperature of the contents is maintained within about 5° C. of the predetermined temperature for the predetermined period of time.

In another embodiment, the method includes charging the temperature control device prior to placing the temperature control device in substantially direct contact with at least a portion of a surface of the object. In yet another embodiment, the phase change material of each enclosure has a melting temperature within about 2° C. of a predetermined temperature, and wherein the temperature of the contents is maintained within about 2° C. of the predetermined temperature for the predetermined period of time. For instance, the predetermined temperature is in a temperature range selected from the group consisting of: (i) about 5° C. to about 10° C.; (ii) about 10° C. to about 15° C.; (iii) about 15° C. to about 20° C.; and (iv) about 70° C. to about 85° C. In various embodiments, the contents comprise a beverage selected from the group consisting of water, tea, coffee, wine, beer, Champaign, and soda.

In one embodiment, the temperature control device comprises a plurality of enclosures in which is disposed a phase change material. Moreover, the phase change material may include one or more organic molecules. For instance, the one or more organic molecules may be selected from the group consisting of an esterified vegetable oil, a long chain fatty acid, a polyol, a paraffin, a polyacrylamide, and a combination thereof.

In another embodiment, each enclosure of the temperature control device used in the method includes a conformable layer that may comprise a flexible polymer. For instance, the flexible polymer may be selected from the group consisting of polyamide, polyethylene, polychlorotrifluoroethene, polystyrene, polyethylene terephthalate, polypropylene, and any combination thereof. In other embodiments, the temperature control device is a wrap and wherein each of the enclosures is connected to at least one other enclosure such that the temperature control device is disposed at least partially around the circumference of the object. In various embodiments, the object is a beverage container. For instance, the beverage container may be selected from the group consisting of a bottle, can, box, and pouch. In various embodiments, the predetermined period of time is at least 1 hour. In others, the predetermined period of time is at least 1.5 hours. In yet others, it is at least 2 hours.

In another aspect of the present invention, a temperature control wrap is featured that includes a plurality of interconnected enclosures in which is disposed a phase change material, wherein each enclosure comprises at least one conformable layer, wherein the phase change material has a melting temperature within about 5° C. of a predetermined temperature, and wherein the temperature control wrap is enabled to maintain at least the surface of a beverage container within about 5° C. of the predetermined temperature for a predetermined period of time when the beverage container is placed in substantially direct contact with one or more of the enclosures. In some embodiments, the predetermined temperature is in a temperature range selected from the group consisting of: (i) about 5° C. to about 10° C.; (ii) about 10° C. to about 15° C.; (iii) about 15° C. to about 20° C.; and (iv) about 70° C. to about 85° C.

In an embodiment, the temperature control wrap includes a phase change material that comprises one or more organic molecules selected from the group consisting of an esterified vegetable oil, a long chain fatty acid, a polyol, a paraffin, a polyacrylamide, and a combination thereof. In another embodiment, the conformable layer of each enclosure of the temperature control wrap comprises a flexible polymer selected from the group consisting of polyamide, polyethylene, polychlorotrifluoroethene, polystyrene, polyethylene terephthalate, polypropylene, and any combination thereof. In some embodiments, each enclosure further comprises at least two conformable layers.

In an embodiment, the temperature control wrap is enabled to be disposed at least partially around the circumference of the beverage container. In another embodiment, the phase change material has a melting temperature within about 2° C. of the predetermined temperature, and wherein the temperature control wrap is enabled to maintain at least the surface of the beverage container within about 2° C. of the predetermined temperature. In other aspects, the predetermined period of time is at least about 1 hour. In still others, the predetermined period of time is at least about 1.5 hours.

The present disclosure also features a method of precisely controlling the temperature of a beverage using the temperature control wrap described above and includes the steps of placing the temperature control wrap in substantially direct contact with at least a portion of a surface of a container containing a beverage and maintaining the temperature control wrap in substantially direct contact with the container for a predetermined period of time. The temperature of the beverage is then maintained within about 5° C. of the predetermined temperature for the predetermined period of time.

In another embodiments, the method includes charging the temperature control wrap prior to placing in substantially direct contact with at least a portion of a surface of the container. In others, the phase change material of each enclosure has a melting temperature within about 2° C. of the predetermined temperature, and wherein the temperature of the beverage is maintained within about 2° C. of the predetermined temperature for the period of time. In various embodiments, the predetermined period of time is at least 1 hour, at least 1.5 hours, or at least 2 hours.

Other features and advantages of the invention will be apparent by references to the drawings, detailed description, and examples that follow.

### BRIEF DESCRIPTION OF THE DRAWINGS

FIG. 1 depicts an exemplary thermal melting profile for a phase change material (“PCM”). The y-axis represents the temperature of the PCM in degrees Celsius, whereas the x-axis represents the heat added to the system over time. Shown is the solid phase, transition phase, and liquid phase of the exemplary PCM.

FIG. 2A depicts a perspective view of an exemplary temperature control device enclosure.

FIG. 2B depicts a cross-sectional view of an exemplary temperature control device enclosure containing a PCM.

FIG. 2C depicts a cross-sectional view of an exemplary embodiment of a temperature control device enclosure containing a PCM.

FIG. 3 depicts a top view of an embodiment of a temperature control device.

FIG. 4 depicts a perspective view of an embodiment of a temperature control device in substantially direct contact with a beverage bottle.

FIG. 5A is a photograph of an exemplary temperature control device.

FIG. 5B is a photograph of an exemplary temperature control device.

FIG. 6 is a photograph of an exemplary temperature control device in substantially direct contact with a beverage bottle.

### DETAILED DESCRIPTION

The present invention springs in part from the inventor's development of a consistent way to precisely control the temperature of an object, such as beverage container, for an extended period of time in order to maintain that object within a desired temperature range. Various aspects of the invention utilize a device by which beverage containers, including, but not limited to wine, Champaign, and beer bottles, are placed in direct contact or substantially direct contact with an enclosure containing a phase-change material (“PCM”) having a melting point within the temperature range desired by the user. It is to be understood that the terms “melting point” and “freezing point” are used interchangeably herein and refer to the temperature at which the PCM changes phases from liquid-to-solid and solid-to-liquid, respectively. In particular aspects, the device is a single unit or a series of connected units (e.g., pouches) of PCM enclosed in a flexible material such that the device can substantially conform to the shape of any beverage container. For instance, the device may be a flexible wrap comprising interconnected PCM enclosures that can be disposed around the outside of a beverage container (e.g., a bottle or can) such that the device can conform to at least a portion of the surface of the container and in direct contact or substantially direct contact with that surface whereby the beverage container (and its contents) is maintained within a desired temperature range for an extended period of time.

The devices and methods of the invention are particularly applicable to apply consistent, continuous, and controlled hot or cold temperatures directly to beverage containers without the need for mechanical heating or cooling, ice, ice buckets, and the like. In addition, the present devices and methods provide the desired temperature control in a precise, easily portable, safe, and efficient manner while reducing costs and energy consumption.

All percentages expressed herein are by weight of the total weight of the composition unless expressed otherwise. All ratios expressed herein are on a weight (w/w) basis unless expressed otherwise.

Ranges may be used herein in shorthand, to avoid having to list and describe each value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a method” or “a container” includes a plurality of such “methods”, or “containers.” Likewise the terms “include”, “including”, and “or” should all be construed to be inclusive, unless such a construction is clearly prohibited from the context. Similarly, the term “examples,” particularly when followed by a listing of terms, is merely exemplary and illustrative and should not be deemed exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of.”

The methods and compositions and other advances disclosed herein are not limited to particular equipment or processes described herein because such equipment or processes may vary. Further, the terminology used herein is for describing particular embodiments only and is not intended to limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

The term “about” refers to the variation in the numerical value of a measurement, e.g., temperature, length, width, height, weight percentage, etc., due to typical error rates of the device used to obtain that measure. In one embodiment, the term “about” means within 5% of the reported numerical value.

The term “substantially direct contact” in reference to an enclosure or device and an object, such as a beverage container, for which temperature control is desired means that the object is placed within a proximity to the enclosure/device such that sufficient heat transfer can occur, e.g., conductive or convective heat transfer, to maintain that object within a pre-determined temperature range for a pre-determined period of time.

The terms “melting point” or “melting temperature” are used interchangeably herein and refer to the temperature at which a solid, such as a solid PCM, changes state from solid to liquid at atmospheric pressure. At the “melting point”, the solid and liquid phase exist in equilibrium.

The terms “freezing point” and “freezing temperature” are used interchangeably herein and refer to the temperature at which a liquid, such as a liquid PCM, changes state from liquid to solid at atmospheric pressure.

The term “thermal conductivity” as used herein refers to the property of a material to conduct heat.

The term “thermal conduction” as used herein refers to the transfer of heat by microscopic collisions of particles and movement of electrons within an object or body.

The term “thermal convection” as used herein refers to the transfer of heat from one place to another by the movement of fluids or gases.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

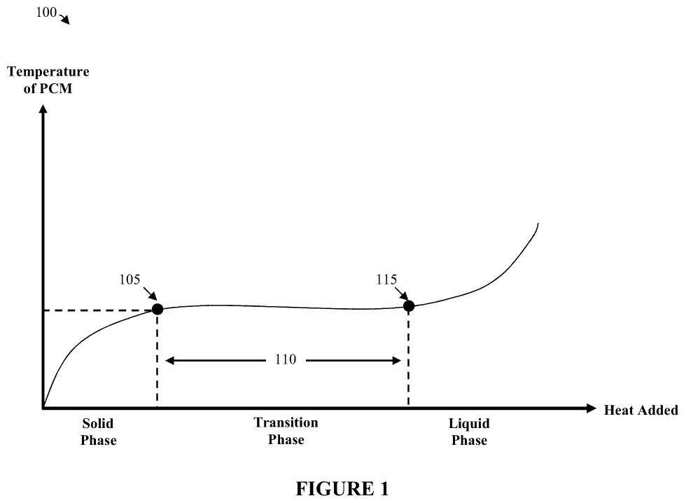

In a particular aspect, the device and method provided herein for the precise temperature control of a beverage will comprise a phase change material. Phase change materials, or PCMs, are materials having a large latent heat and high thermal conductivity. PCMs suitable for use in the present devices and methods should have a melting temperature within a predetermined range of operation, melt congruently with minimum subcooling, and be chemically stable. FIG. 1 represents an exemplary thermal melting profile 100 of a PCM as heat is added to the PCM over time. The temperature of a frozen, or solidified, PCM initially rises in response to a rise in the ambient temperature. At point 105, the PCM reaches its melting temperature. As the PCM undergoes melting and absorbing thermal energy in accordance with its latent heat of fusion, the melting profile 100 reveals a stable thermal plateau during the transitional phase 110. During the transitional phase 110, the temperature of the PCM does not rise. Once the PCM is in a liquid state at point 115, the temperature of the PCM again begins to rise in response to the ambient temperature.

The precise temperature control device and method disclosed herein may be designed based on a particular desired temperature range, or predetermined temperature, and placed in direct contact or substantially direct contact with a beverage container in order to provide stable and consistent heat or cold temperatures to the beverage for extended periods of time. In some aspects, the precise temperature control device is made from a flexible plastic material such that it can conform to the shape of the beverage container. Non-limiting exemplary flexible plastic materials may comprise polyamide (e.g., nylon), polyethylene, high density polyethylene, polychlorotrifluoroethene, polypropylene, polystyrene, polyethylene terephthalate, or any combination of these materials. For instance, in a particular embodiment, the flexible plastic material is a laminate of polyethylene and nylon.

Suitable conforming devices may be in the form of a pouch or wrap. The desired predetermined temperature may depend on the type of beverage for which precise temperature control is desired. Indeed, not all beverages are served at the same temperature. However, in general, it is desired that some beverages be maintained in the predetermined temperature range from about 6° C. to about 25° C. For instance, red wines are typically served at a temperature range from about 15° C. to about 20° C., whereas white wines, sparkling wines, and Champagnes are served at cooler temperatures ranging from about 9° C. to about 13° C. for white wine and sparkling wine and from about 8° C. to about 10° C. for Champagne. A summary of some non-limiting exemplary temperatures for serving particular wines is provided in Table 1. Moreover, drinking water, fruit juices, soda, and the like can be served anywhere from about 6° C. to about 22° C. depending on whether a cold or warm beverage is desired. Other beverages, such as beer are maintained within a temperature range from about 6° C. to about 15° C. (e.g., 6-9° C. for most lagers; 7-11® C. for most ales, India pale ales, porters, and stouts, 4-7° C. for American Pilsners; 10-13° C. for Belgian ales, sour ales, and Bocks). For certain liquors, such as jagermeister and some types of vodkas, colder temperatures are desired (e.g., −18° C. for jagermeister and 0° C. to 4° C. for some vodkas) It some cases, the beverage container contains a hot beverage, such as a hot tea or coffee, in which the desired temperature range is from about 70° C. to about 85° C.

TABLE 1
Precise Temperature Control for Wines.

| ° C. | ° F. | Wine Style |
|---|---|---|
| 19 | 66 | Armagnac, Brandy, Cognac |
| 18 | 64 | Full Bodied Red Wines, Shiraz |
| 17 | 62 | Tawny Port |
| 15 | 59 | Medium Bodied Red Wines |
| 14 | 57 | Amontillado Sherry |
| 13 | 55 | Light Bodied Red Wines |
| 12 | 54 | Full Bodied White Wines |
| 11 | 52 | Medium Bodied White Wines |
| 10 | 50 | Rose, Light Bodied White Wines |
| 9 | 48 | Vintage Sparkling |
| 8 | 46 | Fino Sherry |
| 7 | 45 | Non-Vintage Sparkling |

For any particular desired predetermined temperature range, precise temperature control device enclosures are chosen containing the appropriate PCM material such that the beverage container is maintained within a few degrees of the predetermined temperature. For example, in some embodiments, the predetermined temperature may be a cooler temperature ranging from about 5° C. to about 15° C. In other embodiments, the predetermined temperature may be warmer in the temperature range from about 15° C. to about 25° C. For other embodiments, the temperature range is from about 10° C. to about 20° C. In other embodiments, the predetermined temperature may be suitable for hot beverages in the temperature range from about 70° C. to about 85° C.

Thus, for illustrative purposes, the predetermined temperature may be about −30° C., −29° C., −28° C., −27° C., −26° C., −25° C., −24° C., −23° C., −22° C., −21° C., −20° C., −19° C., −18° C., −17° C., −16° C., −15° C., −14° C., −13° C., −12° C., −11° C., −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., or higher. Preferably, the predetermined temperature is in a temperature range that is suitable for maintaining consistent and precise temperature control of a beverage and beverage container within a few degrees (e.g., within 2 degrees) of a predetermined temperature range, e.g., about 5° C. to about 85° C. In a more preferred embodiment, the predetermined temperature is selected from the group consisting of: (1) about 5° C. to about 10° C.; (2) about 10° C. to about 15° C.; (3) about 15° C. to about 20° C.; (4) about 70° C. to about 80° C.; and (5) about 75° C. to about 85° C.

The PCMs utilized in the devices and methods of this invention are selected based on the predetermined temperature range desired for the particular temperature control. In some embodiments, the PCM is a solid-liquid PCM that has a melting point within the predetermined temperature range to provide precise temperature control to an object, such as a beverage container. In other embodiments, the PCM is a liquid-solid PCM that has a melting point (or freezing point) within the predetermined temperature range to provide precise temperature control to an object. PCMs with melting points over a wide range of temperatures are known in the art, and many are commercially available. In particular embodiments, the PCM melting point is within about 10° C. of a predetermined temperature, e.g., within 10° C., 9° C., 8° C., 7° C., 6° C., 5° C., 4° C., 3° C., 2° C., or 1° C. of a predetermined temperature. In other embodiments, the PCM melting point is within about 5° C. of a predetermined temperature. In yet other embodiments, the PCM melting point is within about 2° C. of a predetermined temperature.

The PCMs disclosed herein may have melting/freezing points from between about −30° C. to about 85° C. depending on the desired application or beverage/liquid for which it is desired to control the temperature. In such embodiments, PCMs may have melting points in the range of about 5° C. to about 15° C. In other embodiments, PCMs with melting points in the range of about 10° C. to about 20° C. are suitable. In yet other embodiments, PCMs with melting points in the range of about 15° C. to about 25° C. are suitable. In one embodiment, PCMs with melting points in the range of about 70° C. to about 80° C. are suitable. In other embodiments, PCMs with melting points in the range of about 75° C. to about 85° C. are suitable. In yet other embodiments, PCMs with melting points in the range from about 0° C. to about 5° C. are suitable. In a preferred aspect, PCMs suitable for use with the present devices and methods have melting temperature ranges selected from (1) about 5° C. to about 10° C.; (2) about 10° C. to about 15° C.; (3) about 15° C. to about 20° C.; (4) about 70° C. to about 80° C.; and (4) about 75° C. to about 85° C. Thus, for illustrative purposes, a PCM may be selected having a melting and/or freezing temperature of about −30° C., −29° C., −28° C., −27° C., −26° C., −25° C., −24° C., −23° C., −22° C., −21° C., −20° C., −19° C., −18° C., −17° C., −16° C., −15° C., −14° C., −13° C., −12° C., −11° C., −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., or higher.

In addition, as one skilled in the art would appreciate, some PCMs may have melting temperatures and freezing temperatures that differ slightly due to a phenomenon known as hysteresis. In such a case, the PCM undergoes melting and absorbing thermal energy in accordance with its latent heat of fusion. However, the transition phase may be observed to be a couple of degrees Celsius higher than that of the freezing temperature for the same PCM. In some embodiments, the precise temperature control device of the instant disclosure is designed using a PCM that undergoes a phase change from liquid to solid. Thus, in some embodiments, PCMs are selected having a freezing temperature of about −30° C., −29° C., −28° C., −27° C., −26° C., −25° C., −24° C., −23° C., −22° C., −21° C., −20° C., −19° C., −18° C., −17° C., −16° C., −15° C., −14° C., −13° C., −12° C., −11° C., −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C. ° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., or higher.

In some applications, very cold temperatures are desired. In such embodiments, PCMs are selected having freezing/melting temperatures as low as −60° C. to about 0° C., e.g., −60° C., −55° C., −50° C., −45° C., −40° C., −35° C., −30° C., −25° C., −20° C., −15° C., −10° C., −5° C., or 0° C. Suitable PCM compositions for very low temperatures include, but are not limited to, propylene glycol mixtures.

Examples of PCMs suitable for use in the present invention include, but are not limited to, PURETEMP™ (Entropy Solutions, INC.), PCM-SP™ (RUBITHERM® GmbH), or SAVENRG™ PCM pouch (Rgees, LLC). Other PCMs are well known in the art (see, e.g., Sharma et al., 2009, “Review on Thermal Energy Storage with Phase Change Materials and Applications,” Renewable and Sustainable Energy Reviews 13:318-345), the content of which is incorporated herein in its entirety. In some embodiments, the PCMs comprise esters of long chain fatty acids (e.g., derived from vegetable materials). In other embodiments, the PCMs comprise polyols, such as glycols, including polyethylene glycols (“PEG”), diols and trials, and mixtures thereof. In yet other embodiments, the PCMs comprise C14 to C34 saturated hydrocarbons. In still other embodiments, the PCMs comprise salts or salt hydrates. In such embodiments, these compounds may be chosen based on the known melting temperature or freezing temperature (see, for example, Table 2). In some embodiments, the PCMs comprise polyols having melting temperatures from about 5° C. to about 25° C. or higher, including hexanediol isomers, PEG 400, PEG 600, glycerin, or mixtures thereof. As one skilled in the art would appreciate, a PCM composition may comprise a combination of polyols having different melting temperatures to alter the melting temperature of the resultant mixture. Therefore, many different phase change temperatures are possible.

In yet other embodiments, the PCMs comprise salts, eutectic salts, salt hydrates (also referred to herein as “hydrated salts” or “hydrates”), paraffin, high density polyethylene, and naphthalene. In some embodiments, the PCMs comprise sodium chloride (“NaCl”), potassium chloride (“KCl”), calcium chloride (“CaCl₂”), or the hydrate thereof. In another embodiment, the PCM comprises calcium chloride hexahydrate (“CaCl₂*6H₂O”) or a mixture of manganese nitrate hexahydrate (“Mn(NO₃)₂*6H₂O”) and manganese chloride hydrate (“MnCl₂*H₂O”). For illustrative purposes, a PCM having melting point of about 22° C. may be obtained from a composition comprising NaCl, a PCM having a melting point of about 11° C. may be obtained from a composition comprising KCl, a PCM having a melting temperature of about 2-6° C. may be obtained from a composition comprising an inorganic salt, a PCM having a melting point of about 23° C. may be obtained from a composition comprising CaCl₂*6H₂O, and a PCM having a melting point of about 37° C. may be obtained from a composition comprising long chain fatty acids or esters of long chain fatty acids. In some embodiments, PCMs having melting temperatures at about 5° C. or higher may be obtained from compositions comprising organic compounds. For instance, suitable PCMs may comprise saturated hydrocarbons (i.e., paraffin) having carbon chains ranging from 14 to 34 (i.e., a “C14 paraffin” to a “C34 paraffin”), it being understood that the increased length of the carbon chain generally correlates with increasing melting temperatures. In other embodiments, suitable PCMs may comprise a mixture of pentadecane and octadecane having a melting temperature of around 9-10° C. A non-limiting list of exemplary PCMs suitable for use herein is provided in Table 2.

TABLE 2
Exemplary PCM Materials.

| | Melting Temp. | |
|---|---|---|
| PCM | (° C.) | Type |
| NaCl*Na₂SO₄*10H₂O | 18 | SH |
| LiCH₃COO*2H₂O | 70 | SH |
| Na₂SiO₃*5H₂O | 72.20 | SH |
| Ba(OH)₂*8H₂O | 78 | SH |
| CaCl₂*6H₂O | 23 | SH |
| MgCl₂*6H₂O | 89 | SH |
| Mn(NO₃)₂ * 6H₂O + MnCl₂*H₂O | 15-25 | EU |
| Cerrobend eutectic | 70 | EU |
| Li₂SO₄ (27.9% w/w) + H₂O (72.1% w/w) | −23 | I |
| Diethylene glycol | −10 | O |
| Trimethylolethane (63% w/w) + H₂O (37% w/w) | 29.8 | O |
| azobenzene | 67 | O |
| Glycerin | 17.9 | O |
| PEG 600 | 20 | O |
| Methyl bromobenzoate | 81 | O |
| azobenzene | 67 | O |
| naphthalene | 80 | O |
| Formic acid | 7.8 | O |
| C-14 Paraffin | 5.5 | O |
| C-15 Paraffin | 10 | O |
| C-16 Paraffin | 16.7 | O |
| C-17 Paraffin | 21.7 | O |
| C-18 Paraffin | 28 | O |
| C-30 Paraffin | 65.4 | O |
| C-31 Paraffin | 68 | O |
| C-32 Paraffin | 69.5 | O |
| C-33 Paraffin | 73.9 | O |
| C-34 Paraffin | 75.9 | O |
| Caprylic acid | 16.3 | FA |
| Phenyl acetic acid | 77 | FA |
| Stearic acid | 70 | FA |
| acetamide | 81 | FA |
| Pentadecane/octadecane mixture | 9-10 | O |

w/w, weight percentage
SH, salt hydrate
EU, eutectic
O, organic
FA, fatty acid
I, inorganic salt solution

In a some aspects, the PCMs comprise a C14- to C34-paraffin or an ester of a long-chain fatty acid or a mixture of different esters of long-chain fatty acids. In such aspects, these PCMs have a latent heat of fusion of at least 20 kJ/Kg, preferably at least 30 kJ/Kg, and have melting points (or freezing points) in the temperature ranges described above. In a particular embodiment, PCM compositions suitable for use in the present disclosure comprise formic acid, a C14-C18 paraffin, a mixture of pentadecane/octadecane, a C30-C34 paraffin, stearic acid, NaOH*H₂O, LiCH₃COO*2H₂O, azobenzene, Ba(OH)_{2*}8H₂O, naphthalene, acetamide, phenyl acetic acid, or MgCl₂*6H₂O. In some embodiments, it may be desirable to provide PCMs for use in the present precise temperature control devices and methods due to their “food safe” characteristics. The term “food safe” refers to compositions that do not impart any poisonous or deleterious substance into foodstuffs such as to render the foodstuffs harmful or otherwise unfit for human and/or animal consumption. Thus, in particular embodiments, the PCMs comprise esters of long-chain fatty acids and/or esterified vegetable oils. For instance, some precise temperature control devices for storing or serving white or red wine may include enclosures containing PCMs having melting temperatures between about 5° C. to about 10° C. or between about 15° C. and about 20° C., respectively. In more preferred embodiments, these PCMs may include esterified vegetable oils.

In some embodiments, the PCM composition may contain additives. For example, in one embodiment, the PCM mixture may comprise a nucleating agent to prevent supercooling or superheating of the PCM. Suitable nucleating agents include, but are not limited to, talc, alkaline earth metal salts, sodium borate, carbon, TiO₂, Copper, Aluminum, Na₂SO₄, SrSO₄, and K₂SO₄. In other embodiments, the PCM mixture may comprise a thickener to prevent subcooling due to phase segregation (e.g., phase segregation of hydrated salts). Suitable thickening agents include, but are not limited to, a superabsorbent polymer made from an acrylic acid copolymer and carboxymethyl cellulose. Suitable thickening agents may be added to the PCM mixture in a range from about 1% by weight to about 10% by weight, preferably from about 2% by weight to about 5% by weight. Thickening and nucleating agents are described in detail in Farid et al., Energy Convers Mgmt 45:1597-1615 (2004), the contents of which is incorporated by reference herein in its entirety.

In some embodiments, an object may be placed in direct contact or substantially direct contact with a precise temperature control device of the present disclosure. The object may be a beverage container, including, but not limited to, a beer keg, a barrel of distilling spirits (e.g., bourbon, scotch, gin, vodka, rye, Irish whiskey) a wine bottle, a bottle of cocktail mixer (e.g., syrup or juice), beer can, beer bottle, wine box, drink pouch, and thermos. In other embodiments, the precise temperature control device is an enclosure containing PCM material and made from flexible material. In still other embodiments, the precise temperature control device is a wrap comprising a plurality of interconnected enclosures containing PCM material.

The PCM composition(s) typically is disposed within an enclosure, which can be made of any material, as long as the material is capable of enclosing the PCM for at least the predetermined time and any additional time needed to charge or equilibrate the PCM at the desired temperature range. Accordingly, the material comprising the enclosure should be substantially inert to the PCM; i.e., not reactive with or degraded by the PCM. Additionally, in some embodiments, the enclosures of the present invention are made out of a conformable and flexible material, such that close contact between the enclosure and the surface of beverage container is achieved. In certain embodiments, the enclosures are comprised of one or more layers of conformable or flexible material. For example, the enclosures can be made of a flexible polymer, including polyamide (e.g., nylon), polyethylene (e.g., high density polyethylene), polychlorotrifluoroethene, polystyrene, polyethylene terephthalate, and polypropylene. In particular embodiments, the precise temperature control device may be a wrap comprising a plurality of interconnected enclosures that the user can wrap around a beverage container. In such embodiments, the precise temperature control device or wrap is in direct (or substantially direct) contact with a portion of the outer surface of the beverage container and conforms to the shape of the beverage container to ensure efficient and precise temperature control of the container contents.

In some embodiments, a PCM enclosure is a square or rectangular shape having dimensions having a length ranging from about 5 in. (12.70 cm) to about 27 in. (68.58 cm) or more, e.g., about 5 in., 6 in., 7 in., 8 in., 9 in., 10 in., 11 in., 12 in., 13 in., 14 in., 15 in., 16 in., 17 in., 18 in., 19 in., 20 in., 21 in., 22 in., 23 in., 24 in., 25 in., 26 in., 27 in., or more, and a width ranging from about 1 in. (2.54 cm) to about 5 in. (7.62 cm) or more, e.g., 1 in., 2 in., 3 in., 4 in., 5 in. or more, such that it can be wrapped around a portion of a cylindrical beverage container. In a preferred embodiment, the enclosures are in the shape of a pouch that is about 2 in. (5.08 cm) wide and about 6 in. (15.24 cm) long. In another embodiment, the device is a wrap comprising a plurality of interconnected enclosures, wherein each enclosure contains a PCM material and has a length ranging from about 5 in. (12.70 cm) to about 8 in. (20.32 cm) or more and a width ranging from about 1 in. (2.54 cm) to about 3 in. (7.62 cm) or more (e.g., 2 in.×6 in.). In this embodiment, the number of enclosures in the wrap may be from 2 to 10 or more enclosures; preferably from 6 to 9 enclosures. In some embodiments, the individual enclosures are interconnected along their lengths and, thus, the wrap may have a total length of about 10 in. (about 25.40 cm) to about 30 in. (about 76.2 cm) in length and can be wrapped about an outer portion of a beverage container. For instance, in one particular embodiment, the wrap includes a plurality of 2 in.×6 in. enclosures interconnected along their lengths giving the wrap a width of about 6 inches (15.24 cm) and a total length of about 27 inches (68.58 cm).

In some aspects, it is desirable to use much larger PCM enclosures, such as those having dimensions with a length of about 12 in. (30.48 cm) to about 30 in. (76.2 cm) or more and a width of about 5 in. (12.70 cm) to about 12 in. (30.48 cm) or more. These larger PCS enclosures can be used to construct wraps containing 2 to 15 or more enclosures to be wrapped around a portion of a barrel or other large, cylindrical beverage container, such as a bourbon barrel or a beer keg.

Moreover, the PCM material in each of the enclosures may be the same PCM material or may be a different PCM material; preferably it is the same PCM material (e.g., esterified vegetable oil). In some embodiments, the wrap may comprise a continuous flexible polymer that is heat sealed at regular intervals about the length of the wrap to form distinct compartments capable of enclosing a PCM material thus forming a flexible wrap comprising a plurality of PCM enclosures. As discussed above, the conformable or flexible polymer, includes, but is not limited to, polyamide (e.g., nylon), polyethylene (e.g., high density polyethylene), polychlorotrifluoroethene, polystyrene, polyethylene terephthalate, and/or polypropylene.

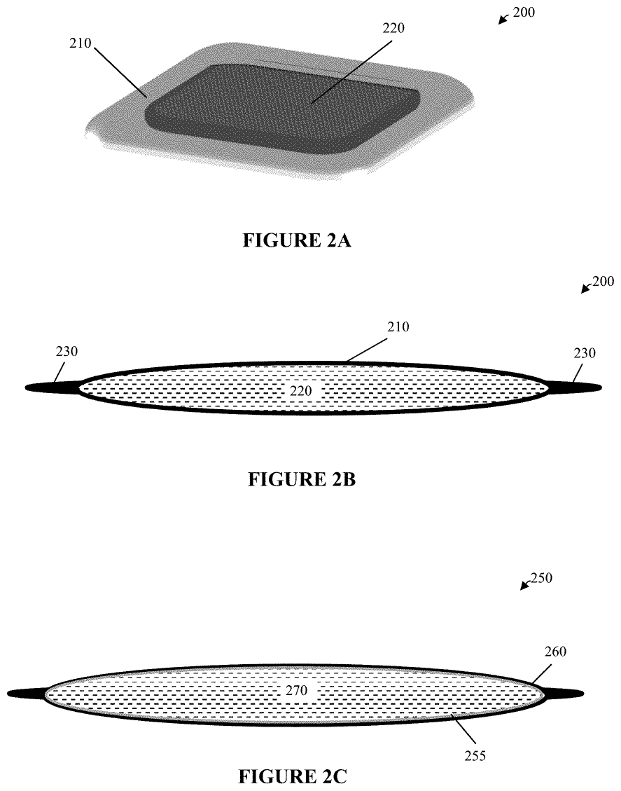

FIG. 2A depicts a non-limiting example of a single PCM enclosure 200 comprising a flexible polymer 210 enclosing a PCM material 220. FIG. 2B depicts a cross-sectional view of a non-limiting example of the PCM enclosure 200. The enclosure 200 comprises a conformable layer 210, which can be a flexible polymer, including polyamide (e.g., nylon), polyethylene (e.g., high density polyethylene), polychlorotrifluoroethene, polystyrene, polyethylene terephthalate, and polypropylene. The edges of the enclosures 230 are sealed to prevent leaks or contamination of the PCM 220. In a particular embodiment, the enclosure 200 may be a pouch that is about 2 in. (5.08 cm) wide by about 6 in. (15.24 cm) long and is made from a flexible plastic material.

In some embodiments, the enclosure is comprised of multiple conformable layers. In one embodiment, the PCM enclosures are comprised of two conforming layers, such as, but not limited to, polyethylene and nylon. As shown in FIG. 2C, the PCM enclosure 250 comprises two conformable layers that include an inner layer 255 and an outer layer 260, which in turn, enclose the PCM material 270. In certain embodiments, inner layer 255 is made of a flexible polymer, including polyamide (e.g., nylon), polyethylene (e.g., high density polyethylene), polychlorotrifluoroethene, polystyrene, polyethylene terephthalate, and/or polypropylene. In such embodiments, the outer layer 260 is also comprised of a flexible polymer, which may be the same flexible polymer as in the inner layer 255 or a different flexible polymer. In one particular embodiment, the PCM enclosure 250 may be a pouch that is 2 in. (5.08 cm) wide by about 6 in. (15.24 cm) long and the flexible layers comprise laminated polyethylene and nylon.

To construct the precise temperature PCM enclosures provided herein, the enclosures are filled with any of the PCM compositions discussed above and then sealed using any suitable means known in the art, including, but not limited to, heat sealing with an impulse sealer or laminator, hot bar sealer, continuous heat sealer, induction sealer, ultrasonic welder, hot wire sealer, or hot melt adhesive. To this end, each enclosure is filled with between about 30 g to about 100 g PCM composition, e.g., 30 g, 35 g, 40 g, 45 g, 50 g, 55 g, 60 g, 65 g, 70 g, 75 g, 80 g, 85 g, 90 g, 95 g, or 100 g PCM composition; preferably between about 50 g and 75 g of PCM composition.

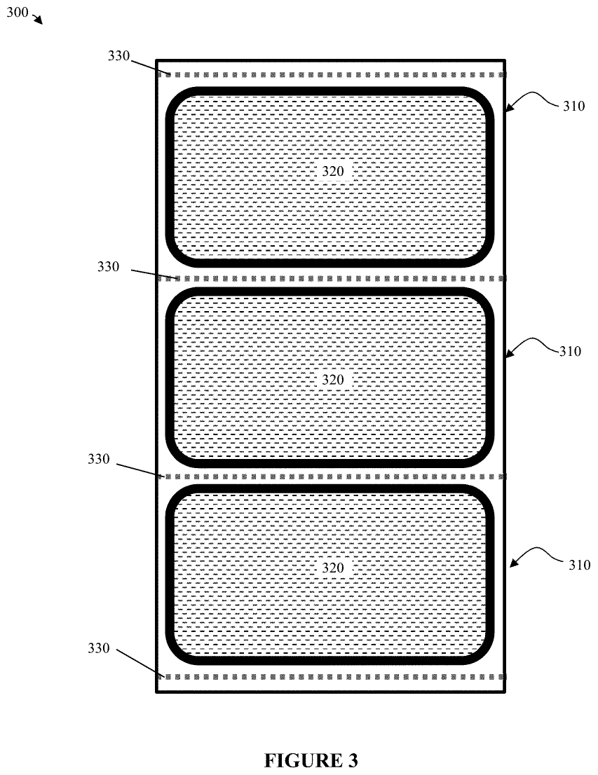

Depicted in FIG. 3 is a portion of an exemplary precise temperature control wrap. As shown in FIG. 3, the precise temperature control wrap 300 is comprised of multiple interconnected PCM enclosures 310, wherein each enclosure contains a PCM material 320. In this particular embodiment, the precise temperature control wrap 300 is made from a single sheet of flexible polymer and heat sealed at regular intervals 330 to create the plurality of distinct but interconnected PCM enclosures. For instance, the precise temperature control wrap 300 may be manufactured by filling the first PCM enclosure and heat sealing, filling the second PCM enclosure and heat sealing, and so on. In certain embodiments, the enclosures comprise two or more layers made from, e.g., flexible polymer. The precise temperature control wrap is enabled to be disposed around the circumference of a beverage container, e.g., a bottle, such that the outer surface of the bottle is in substantially direct contact with the enclosures of the precise temperature control wrap. As one having ordinary skill in the art would recognize, the precise temperature control wrap can be disposed around, on, and/or over any shape of beverage container to maintain the temperature of the beverage within about 2° C. to about 5° C. of a predetermined temperature for a predetermined period of time.

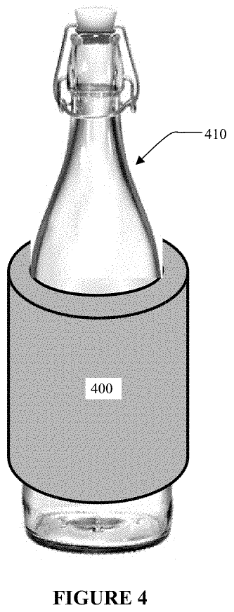

As noted above, the precise temperature control devices provided herein can be a single enclosure or may be comprised of two or more interconnected enclosures. In either case, the precise temperature control device can be made from a flexible material and of sufficient length to wrap around the circumference of a portion of the outer service of a beverage container. For instance, depicted in FIG. 4 is a drawing of a non-limiting exemplary precise temperature control device 400 comprising a single PCM enclosure. As shown in FIG. 4, the precise temperature control device 400 can be wrapped around a beverage container 410 such that the PCM enclosure is in direct contact or substantially direct contact with a portion of the outer surface of the beverage container 410 thereby maintaining the temperature of the beverage within about 5° C. of a predetermined temperature for a predetermined period of time; preferably, within about 2° C. of a predetermined temperature for the predetermined period of time. In some embodiments, the predetermined period of time is at least 30 min., e.g., 30 min., 40 min., 50 min., 60 min., 70 min., 80 min., 90 min., 100 min., 110 min., 120 min., 3 h, 4 h, 5 h, 6 h, or more. In preferred embodiments, the predetermined period of time is at least 1 hour.

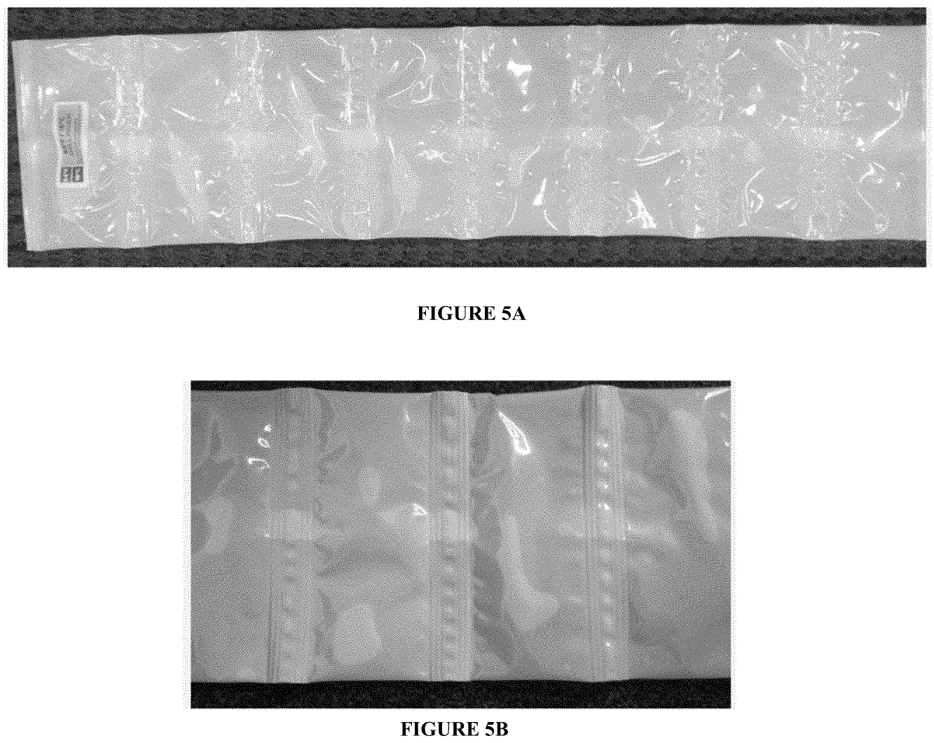

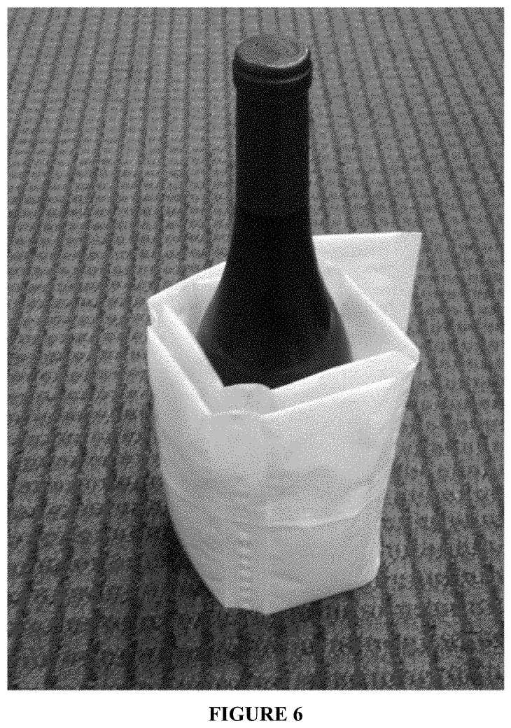

FIG. 5A and FIG. 5B are photographs showing an exemplary precise temperature control device comprising a plurality of interconnected PCM enclosures. As shown in FIG. 6, the precise temperature control device comprising a plurality of interconnected PCM enclosures can be disposed around the circumference of a cylindrical or bottle-shaped beverage container (such as a wine bottle) for precise temperature control of the beverage contained therein. However, it being understood that the precise temperature control device can also be disposed around or on other types of beverage containers, including, but not limited to, cans, boxes, pouches, and the like, such that at least a portion of the beverage container is in substantially direct contact with the enclosures of the precise temperature control device.

Also described herein is a method for applying precise temperature control to a container within which a beverage is disposed. In such an embodiment, the beverage may be cold or hot, and the container may be made from any material typical of beverage containers (e.g., plastic, metal, or ceramic). In each case, a temperature control device is provided. The temperature control device may be comprised of at least one enclosure containing a PCM having a melting temperature within about 10° C. of a predetermined temperature, preferably within about 7° C. of a predetermined temperature, most preferably within about 2° C. of a predetermined temperature. The predetermined temperature depends upon the particular thermal transfer and/or temperature control that is desired. For example, for beverages that are served, transferred, and/or stored at cooler temperatures, the predetermined temperature is in a range from about 5° C. to about 15° C. In other examples, the beverages are served, transferred, and/or stored at temperatures at slightly higher temperatures, and the desired predetermined temperatures range is from about 10° C. to about 20° C. In still other examples, beverages are served, transferred, and/or stored at hot/warm temperatures ranging from about 70° C. to about 85° C.

In general, the devices containing the PCM must be charged prior to use. For example, if the PCM is to be used in a frozen, or solid state (e.g., a PCM having a melting temperature around 6° C.), then the enclosure(s) containing the PCM is placed in an environment below the melting temperature to allow the PCM material to solidify. In other embodiments, the PCM material is to be used in a melted, or liquid state (e.g., a PCM having a melting temperature around 43° C.). In such an embodiment, the enclosure(s) containing the PCM is placed in an environment above the melting temperature to allow the PCM material to liquefy. For instance, for temperature control devices containing PCM compositions with melting temperatures from around 0° C. to about 10° C., the devices may be charged at about 2° C., e.g., placed in a refrigerator, for about 24 hours. The temperature control device is then ready for use. For temperature control devices containing PCM compositions with melting temperatures from around 10° C. to about 30° C., the charging method may depend on the ambient temperature. For instance, when ambient conditions are around 25° C. or higher, the temperature control device is typically charged at about 15° C., e.g., placed in a refrigerator, for about 24 hours. On the other hand, when ambient conditions are lower than around 25° C., the temperature control device may be charged at about 30° C., e.g., placed in a warming chamber or water bath, for about 24 hours. In either case, the temperature control devices should be set out at room temperature for about 20 to 30 minutes prior to use. For temperature control devices containing PCM compositions with melting temperatures above 70° C., the devices are charged at a high enough temperature to allow melting of the PCM composition, e.g., placed in a hot water bath set at 80° C. or higher, until the PCM material is in a liquid state. The temperature control devices should then be cooled to the appropriate temperature prior to use.

After charging, the temperature control device is placed in direct contact or substantially direct contact with a beverage container, such that the enclosures of the precise temperature control device are maintained in direct contract or substantially direct contact with the container for up to the predetermined time to maintain the temperature of the container within about 7° C. of the predetermined temperature for up to the predetermined time; preferably, within about 5° C. of the pre-determined temperature for up to the predetermined time or within about 2° C. of the pre-determined temperature for up to the predetermined time.

In some embodiments, the beverage container is upside down or maintained in an inverted position and the temperature control device is placed in direct contact or substantially direct contact with the beverage container while the container is in the inverted position such that the enclosures of the precise temperature control device are maintained in direct contract or substantially direct contact with the container for up to the predetermined time to maintain the temperature of the container within about 7° C. of the predetermined temperature for up to the predetermined time; preferably, within about 5° C. of the pre-determined temperature for up to the predetermined time or within about 2° C. of the pre-determined temperature for up to the predetermined time. In a particular embodiment, the beverage container is held in the inverted position by a rack or mounting device (e.g., an upside down bottle dispenser or inverted liquor dispenser).

Additionally, the temperature control device can be used to maintain precise temperature control of liquids other than beverages. For instance, the devices disclosed herein can be used to control the temperature of blood products prior to transfusion or other medicines prior to administration. For instance, the temperature control device can be placed in direct contact or substantially direct contact with a bottle or bag of blood or saline to maintain the container within about 7° C. of the predetermined temperature for up to the predetermined time; preferably, within about 5° C. of the pre-determined temperature for up to the predetermined time or within about 2° C. of the pre-determined temperature for up to the predetermined time.

The predetermined time can be any period of time during which is desired to maintain the precise temperature range without mechanical heating or cooling or the use of ice or open flames. In some embodiments, the predetermined time is typically a few minutes to several hours. For example, the predetermined time may be 1, 2, 3, 4, 5, 6, 7, 8, 9, 10 minutes or more. In other examples, the predetermined time may be 10, 20, 30, 40, 50 minutes or up to an hour. For other embodiments, the predetermined time is up to about 1, 2, 3, 4, 5, 6, 7, 8, 9, 10, or 11 hours. In yet other embodiments, the predetermined time is longer, e.g., 15, 18, 21, or 24 hours. In a preferred embodiment, the predetermined time is in the range from about 1 hour to about 12 hours. In a more preferred embodiment, the predetermined period of time is at least about 1 hour, e.g., 1, 1.5, 2, 2.5, 3, 3.5, 4, 4.5, 5, 5.5, 6, 7, 8, 9, 10, 11, 12 hours or more. For instance, in one particular embodiment, the predetermined period of time is at least about 1.5 hours.

Thus, this relatively simple and straightforward system can be used to provide a consistent, continuous, and controlled temperatures to provide precise temperature control to a container containing a beverage. In addition, the precise temperature control devices disclosed herein represent increased efficiency and safety for transporting, serving, and/or storing beverages while reducing costs and energy consumption.

The following examples are provided to describe the present systems, devices, and methods in greater detail. They are intended to illustrate, not to limit, the invention.

### EXAMPLES

### Example 1

An optimal drinking temperature for a Shiraz was determined to be about 18° C./64° F. A precise temperature control wrap comprising a series of interconnected PCM enclosures made from laminated polyethylene and nylon was used to control the temperature of the wine. Specifically, the PCM compositions contained esterified vegetable oils have a melting temperature of about 18° C. The precise temperature control device was first placed in a refrigerator set at about 15° C. and charged for 24 hours. The charged device was wrapped around the base of the wine bottle such that the enclosures of the device were in substantially direct contact with the outer surface of the bottle as shown in FIG. 6. The temperature of the wine was maintained at around 18° C. for at least 90 minutes.

### Example 2

Optimal drinking temperature for gin is around 13° C. to 16° C. A precise temperature control wrap comprising a series of interconnected PCM enclosures made from laminated polyethylene and nylon was used to control the temperature of the gin. Specifically, the PCM compositions contained fatty acids have a melting temperature of about 16° C. The bottle of gin was placed in an inverted liquor rack and the charged precise temperature control device was wrapped around the based on the bottle such that the enclosures of the device were in substantially direct contact with the outer surface of the bottle. A stop cock was placed in the bottle opening so that it need only be actuated to pour gin into a glass to provide a gin martini at the best temperature for imbibing.

The present invention is not limited to the embodiments described and exemplified herein, but is capable of variation and modification within the scope of the appended claims. cm I claim:

1. A temperature control device comprising:
a plurality of enclosures in which is disposed a phase change material, wherein each enclosure comprises at least one conformable layer comprising a flexible polymer selected from the group consisting of polyamide, polyethylene, polychlorotrifluoroethene, polystyrene, polyethylene terephthalate, polypropylene, and any combination thereof;
wherein the phase change material has a melting temperature within about 5° C. of a predetermined temperature;
wherein the predetermined temperature is in a temperature range selected from about −30° C. to about 85° C.; and
wherein the temperature control device is enabled to maintain at least the surface of an object within about 5° C. of the predetermined temperature for at least about 10 minutes when the object is placed in substantially direct contact with one or more of the enclosures.

2. The temperature control device of claim 1, wherein the predetermined temperature is in a temperature range selected from the group consisting of: (i) about 5° C. to about 10° C.; (ii) about 10° C. to about 15° C.; (iii) about 15° C. to about 20° C.; and (iv) about 70° C. to about 85° C. and wherein the phase change material comprises one or more organic molecules selected from the group consisting of an esterified vegetable oil, a long chain fatty acid, a polyol, a paraffin, a polyacrylamide, and a combination thereof.

3. The temperature control device of claim 1, wherein each of the enclosures is connected to at least one other enclosure and wherein the temperature control device is enabled to be disposed at least partially around the circumference of a beverage container.

4. The temperature control device of claim 1, wherein the temperature control device maintains the surface of the object within about 2° C. of the predetermined temperature for at least about 1 hour when the object is placed in substantially direct contact with one or more of the enclosures.

5. A method for controlling temperature of an object within a predetermined temperature range for a predetermined time period, the method comprising:
(a) providing a temperature control device comprising a plurality of enclosures in which is disposed a phase change material, wherein each enclosure comprises at least one conformable layer comprising a flexible polymer selected from the group consisting of polyamide, polyethylene, polychlorotrifluoroethene, polystyrene, polyethylene terephthalate, polypropylene, and any combination thereof, and wherein the phase change material has a melting temperature within about 5° C. of a predetermined temperature;
(b) placing the temperature control device in substantially direct contact with at least a portion of a surface of an object, wherein the object comprises contents; and
(c) maintaining the temperature control device in substantially direct contact with the object for a predetermined period of time;
whereby the temperature of the contents is maintained within about 5° C. of the predetermined temperature for the predetermined period of time.

6. The method of claim 5, further comprising charging the temperature control device prior to placing the temperature control device in substantially direct contact with at least a portion of a surface of the object.

7. The method of claim 5, wherein the phase change material of each enclosure has a melting temperature within about 2° C. of a predetermined temperature, and wherein the temperature of the contents is maintained within about 2° C. of the predetermined temperature for the predetermined period of time.

8. The method of claim 5, wherein the predetermined temperature is in a temperature range selected from the group consisting of: (i) about 5° C. to about 10° C.; (ii) about 10° C. to about 15° C.; (iii) about 15° C. to about 20° C.; and (iv) about 70° C. to about 85° C.

9. The method of claim 5, wherein the phase change material comprises one or more organic molecules selected from the group consisting of an esterified vegetable oil, a long chain fatty acid, a polyol, a paraffin, a polyacrylamide, and a combination thereof.

10. The method of claim 5, wherein the temperature control device is a wrap and wherein each of the enclosures is connected to at least one other enclosure such that the temperature control device is disposed at least partially around the circumference of the object.

11. The method of claim 5, wherein the object is a beverage container and the contents comprise a beverage selected from the group consisting of water, tea, coffee, wine, beer, Champaign, and soda.

12. The method of claim 5, wherein the predetermined period of time is at least 1 hour.

13. The method of claim 12, wherein the predetermined period of time is at least 2 hours.

14. A temperature control wrap comprising:
a plurality of interconnected enclosures in which is disposed a phase change material, wherein each enclosure comprises at least one conformable layer comprising a flexible polymer selected from the group consisting of polyamide, polyethylene, polychlorotrifluoroethene, polystyrene, polyethylene terephthalate, polypropylene, and any combination thereof;
wherein the phase change material has a melting temperature within about 5° C. of a predetermined temperature; and
wherein the temperature control wrap is enabled to maintain at least the surface of a beverage container within about 5° C. of the predetermined temperature for a predetermined period of time when the beverage container is placed in substantially direct contact with one or more of the enclosures.

15. The temperature control wrap of claim 14, wherein the predetermined temperature is in a temperature range selected from the group consisting of: (i) about 5° C. to about 10° C.; (ii) about 10° C. to about 15° C.; (iii) about 15° C. to about 20° C.; and (iv) about 70° C. to about 85° C.

16. The temperature control wrap of claim 14, wherein the phase change material comprises one or more organic molecules selected from the group consisting of an esterified vegetable oil, a long chain fatty acid, a polyol, a paraffin, a polyacrylamide, and a combination thereof.

17. The temperature control wrap of claim 14, wherein each enclosure further comprises at least two conformable layers.

18. The temperature control wrap of claim 14, wherein the temperature control wrap is enabled to be disposed at least partially around the circumference of the beverage container.

19. The temperature control wrap of any one of claim 14, wherein the phase change material has a melting temperature within about 2° C. of the predetermined temperature, and wherein the temperature control wrap is enabled to maintain at least the surface of the beverage container within about 2° C. of the predetermined temperature.

20. The temperature control wrap of claim 19, wherein the predetermined period of time is at least about 1 hour.
